(19) United States
(12) Patent Application Publication
(10) Pub. No.: US 2025/0311875 A1
(43) Pub. Date: Oct. 9, 2025

(54) MICROWAVE POT

(71) Applicant: Huamin PENG, Foshan (CN)

(72) Inventor: Huamin PENG, Foshan (CN)

(21) Appl. No.: 19/243,298

(22) Filed: Jun. 19, 2025

Related U.S. Application Data
(63) Continuation of application No. PCT/CN2023/095914, filed on May 24, 2023.

(30) Foreign Application Priority Data
May 24, 2023 (CN) 202321261440.3

(51) Int. Cl. A47J 27/00; B65D 81/34

(52) U.S. Cl. CPC A47J 27/00; B65D 81/3446

(57) ABSTRACT

A microwave pot includes an upper lid made of metal and a pot body. A microwave absorption layer is provided on the outer surface of the bottom wall of the pot body and used for absorbing electromagnetic waves emitted by a microwave oven and converting into heat. An opening of the upper lid and/or the pot body is provided with a first flange; a plurality of first through holes are formed in the first flange; silica gel members are provided on the upper and lower surfaces wrapping the first flange; the silica gel members are integrally formed with the first flange and fill the first through holes, thus the silica gel members cannot be separated from the first flange after molding. The first flange and the silica gel members are integrally formed, which improves the combination firmness, and improves user experience of a user.

### CROSS-REFERENCE TO RELATED APPLICATIONS

This application claims priority to Chinese Patent Application No. 202321261440.3, filed on May 24, 2023; and PCT/CN2023/095914, filed on May 24, 2023 which are hereby incorporated by reference in its entirety.

### TECHNICAL FIELD

The present invention relates to the technical field of microwave cookers, and specifically relates to a microwave pot.

### BACKGROUND

Currently, there are microwave baking trays specifically designed for microwave ovens on the market, for example, the Chinese invention US201720010916.4 published with the title of microwave pot on Dec. 8, 2017, the microwave pot includes a pot body and a pot lid, and the edge of the pot lid extends outward to form a lid rim. The structure of the pot body is a metal pot-shaped body, with an extension at an opening edge forming a pot rim. The lid rim overlaps with the pot rim, and a main body of the pot lid is made of metal material, and the outer surfaces of the pot lid and pot body are covered with microwave absorption layers. The metal edges of a pot body opening and a pot lid opening are not separated by insulating members, and there is no integrally formed annular roll rim handle, which not only makes the product appearance not upscale but may also lead to ignition issues.

### SUMMARY

An objective of the present invention is to provide a microwave pot which is provided with handles of an integrally-formed roll rim structure, so as to overcome the defects in the prior art.

A microwave pot includes an upper lid made of metal and a pot body; a microwave absorption layer is provided on an outer surface of a bottom wall of the pot body and is used for absorbing electromagnetic waves emitted by a microwave oven and converting the absorbed electromagnetic waves into heat; the microwave pot is characterized in that an opening of the upper lid and/or an opening of the pot body is provided with a first flange; a plurality of first through holes are formed in the first flange; silica gel members are provided on the upper and lower surfaces wrapping the first flange; and the silica gel members and the first flange are integrally formed and the silica gel members fill the first through holes, so that the silica gel members cannot be separated from the first flange after molding.

The opening of the pot body is provided with the first flange, each silica gel member includes a first handle, a first main body, and a skirt edge which protrudes upwards along the first main body, and the inner side of the skirt edge is covered with the upper lid.

The first handles are bent downwards from inside to outside.

Anti-skid protrusions are arranged on the surfaces of the first handles.

The first flange is arranged on the opening of the upper lid, a second flange is arranged on the opening of the pot body, at least one pair of second through holes is formed in the second flange, a second handle is installed on the second through holes, and the second handle includes a handle cover and a handle base which are buckled to each other.

The handle cover is provided with second fixing columns which are inserted into the second through holes and are in close fit connection with an anti-skid base.

A top portion of the upper lid is covered with the microwave absorption layer, and the silica gel members wrap the outer surface of the upper lid and cover the microwave absorption layer; and the silica gel members are provided with clearances corresponding to the handle cover, and bottom portions of the silica gel members are attached to the second flange outside the second handle.

The opening of the upper lid and the opening of the pot body are provided with the first flanges, and each silica gel member includes a first annular roll rim handle integrally formed with the upper lid, and a second annular roll rim handle integrally formed with the pot body.

The second annular roll rim handles are provided with limiting edges which extend upwards.

The opening of the upper lid is provided with the first flange, the opening of the pot body is provided with the second flange, at least one pair of second through holes is formed in the second flange, a third handle is installed on the second through holes, a top portion of the upper lid is covered with the microwave absorption layer, and the silica gel members wrap the outer surface of the upper lid and cover the microwave absorption layer; and the silica gel members are provided with the clearances corresponding to the third handle, and the bottom portions of the silica gel members are attached to the second flange outside the third handle.

The microwave pot according to the present invention has the benefits that: the first flanges are provided on the opening of the upper lid and/or the opening of the pot body and integrally formed with the silica gel members, the silica gel members are taken as the flange roll rim structures of the upper lid or the pot body, have heat insulation and anti-scald functions and are stably combined with the metal upper lid or the pot body, so that the service life of a product is prolonged, the grade of the product is improved, and the use experience of a user is improved.

### BRIEF DESCRIPTION OF THE DRAWINGS

FIG. 1 is a three-dimensional diagram of an Embodiment 1 according to the present invention;

FIG. 2 is an exploded diagram of an Embodiment 1 according to the present invention;

FIG. 3 is a section diagram of an upper lid of an Embodiment 1 according to the present invention;

FIG. 4 is a three-dimensional diagram of an Embodiment 2 according to the present invention;

FIG. 5 is an exploded diagram of an Embodiment 2 according to the present invention;

FIG. 6 is a section diagram of an upper lid of an Embodiment 2 according to the present invention;

FIG. 7 is a section diagram of a second handle of an Embodiment 2 according to the present invention;

FIG. 8 is a three-dimensional diagram of an Embodiment 3 according to the present invention;

FIG. 9 is an exploded diagram of an Embodiment 3 according to the present invention;

FIG. 10 is a section diagram of an annular roll rim handle of an Embodiment 3 according to the present invention;

FIG. 11 is a three-dimensional diagram of a third handle of an Embodiment 4 according to the present invention; and

FIG. 12 is a section diagram of a third handle of an Embodiment 4 according to the present invention.

### DESCRIPTION OF EMBODIMENTS

The following describes the embodiment of the present invention in detail, and the description of the embodiment with reference to the accompanying drawings is illustrative only and intended to explain the present invention, and should not be construed as a limitation on the present invention.

### Embodiment 1

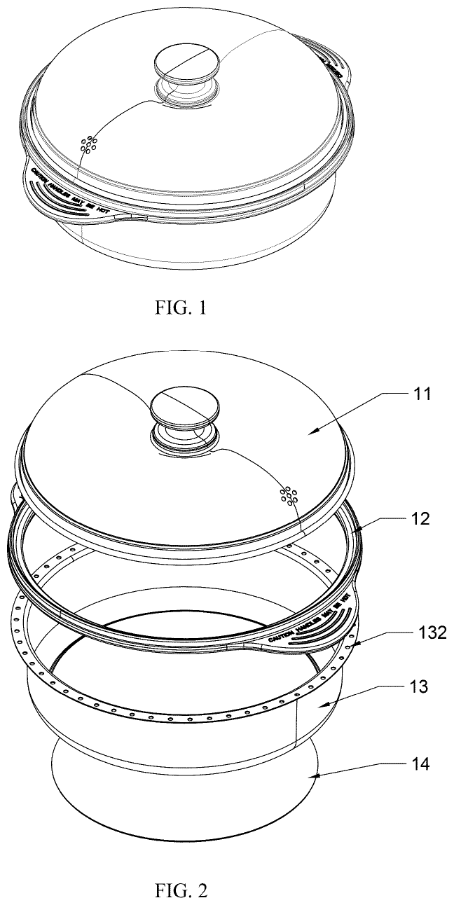

With reference to FIG. 1 to FIG. 3, a microwave pot includes an upper lid 11 made of metal and a pot body 13; a microwave absorption layer 14 is provided on an outer surface of a bottom wall of the pot body 13, and the microwave absorption layer 14 is used for absorbing electromagnetic waves emitted by a microwave oven and converting the absorbed electromagnetic waves into heat; an opening of the upper lid 13 is provided with a first flange 131; a plurality of first through holes 132 are formed in the first flange 131; silica gel members are provided on the upper and lower surfaces wrapping the first flange; and the silica gel members 12 and the first flange are integrally formed and the silica gel members fill the first through holes 132, so that the silica gel members 12 cannot be separated from the first flange 131 after molding.

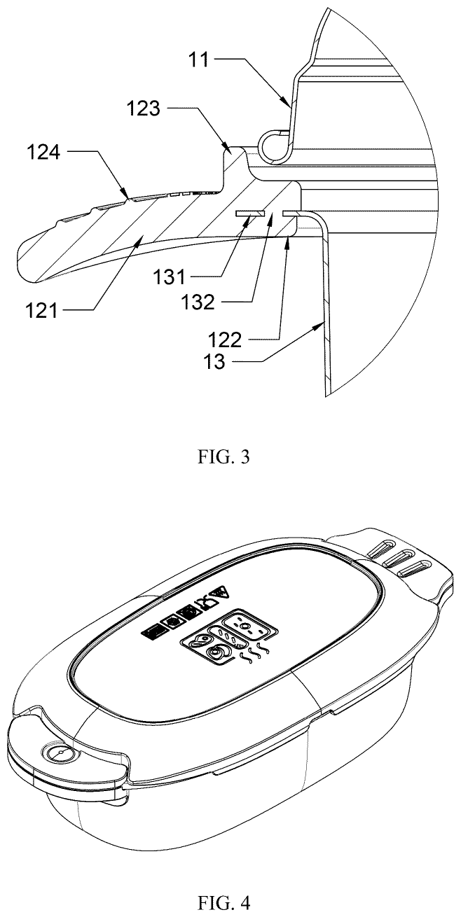

With reference to FIG. 3, each silica gel member 12 includes a first handle 121, a first main body 122, and a skirt edge 123 which protrudes upwards along the first main body 121, and the upper lid 11 covers the inner side of the skirt edge 123. The first handles 121 are bent downwards from inside to outside. Anti-skid protrusions 124 are arranged on the surfaces of the first handles 121.

### Embodiment 2

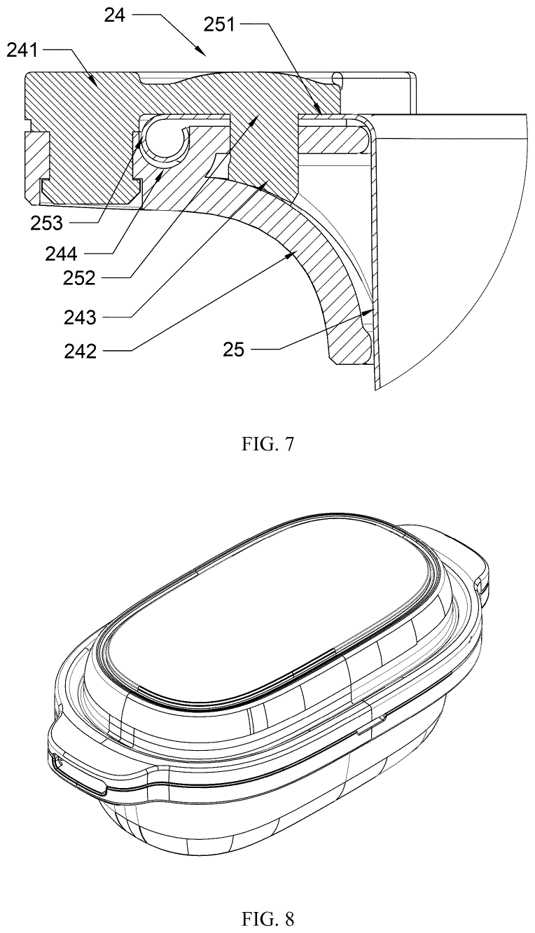

With reference to FIG. 4 to FIG. 7, in this embodiment, a new design is performed on the flange structure of the upper lid and the pot body on the basis of the Embodiment 1, in which, the opening of the pot body and the upper lid can be circular or oval or in a runway shape or the like, and the runway-shaped opening of the pot body is taken as an example below. An upper lid 23 made of metal is provided with a first flange 231, and an opening of a metal pot body 25 is provided with a second flange 251; the second flange 251 is provided with four second through holes 252, and the second flange is provided with a second flange roll rim 253; a second handle 24 is installed on the second through holes 252, and the second handle 24 includes a handle cover 241 and a handle base 242 which are buckled to each other; anti-skid grooves are formed in the handle cover 241 and the handle base 242; and the handle base 242 is provided with a fixing groove 244 matched with the flange roll rim 253. The handle cover 241 is provided with a first fixing column 243 which is inserted into the second through holes 252 and is in close fit connection with a hole of the handle base 242. Two plate edges are arranged at the inner end of the handle base 242 close to the pot body and abut against the side wall of the pot body, and therefore the second handle and the pot body are connected more firmly.

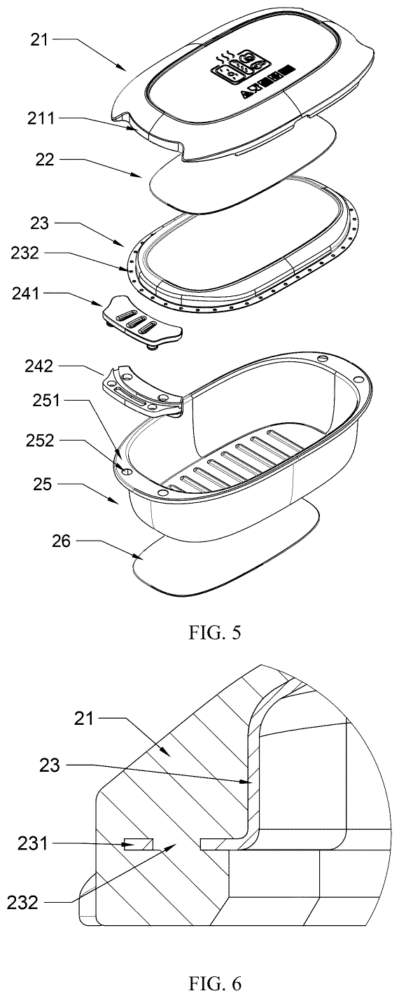

With reference to FIG. 5, the top portion of the upper lid 23 is covered with a microwave absorption layer 22, and silica gel members 21 wrap the outer surface of the upper lid 23 and cover a microwave absorption layer 22; and the silica gel members 21 are provided with clearances 211 corresponding to the handle cover 24, and the bottom portions of the silica gel members 21 are attached to the second flange 251.

The materials of the second handle 24 include but not limited to silica gel or plastic, and assemblies of the second handle are connected by buckles or screws or ultrasonic welding.

The rest of structures are the same as those in the Embodiment 1, and will not be listed here.

### Embodiment 3

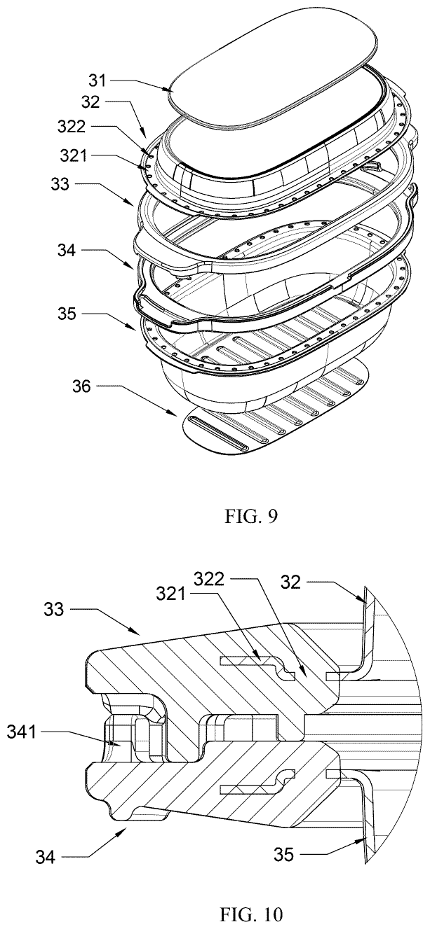

With reference to FIG. 8 to FIG. 10, in this embodiment, a new design is performed on the flange structures of the upper lid, the pot body and the silica gel members on the basis of the Embodiment 1, a runway-shaped pot body opening is adopted, the opening of an upper lid 32 and the opening of a pot body 35 are both provided with flanges 321, a plurality of first through holes 322 are formed in the flanges, the silica gel members are arranged on the upper surfaces and the lower surfaces wrapping the flanges 321, the silica gel members and the flanges 321 are integrally formed and the silica gel members fill the first through holes 322, and the silica gel members cannot be separated from the flanges 321 after molding. Each silica gel member includes a first annular roll rim handle 33 integrally formed with the upper lid, and a second annular roll rim handle 34 integrally formed with the pot body. The top portion of the upper lid is covered with a microwave absorption layer 31.

Each second annular roll rim handle 34 is provided with a limiting edge 341 which extends upwards.

### Embodiment 4

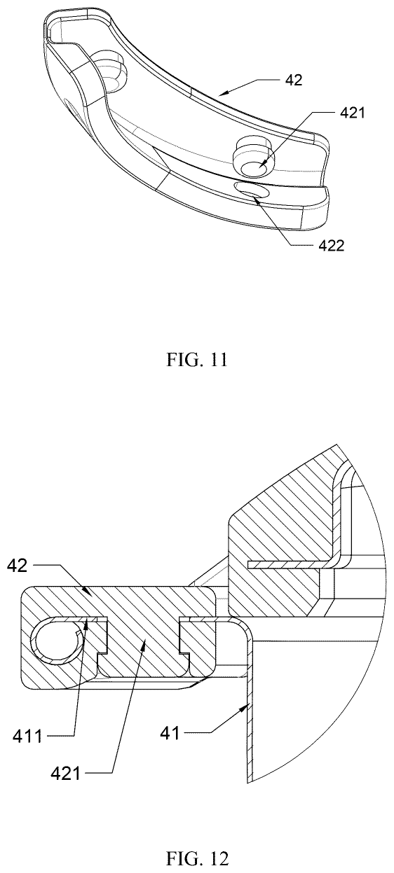

With reference to FIG. 11 and FIG. 12, in this embodiment, a new designed is made on the basis of the Embodiment 2, the pot body 41 is provided with a second flange 411, a third handle 42 replaces the second handle in the Embodiment 2, the third handle 42 is made of bendable soft rubber and is provided with a third through hole 422 and a second fixing column 421 which are correspondingly buckled to each other; and the third handle 42 is bent to wrap the second flange 411.

The rest of structures are the same as those in the Embodiment 2, and will not be listed here.

What is claimed is:

1. A microwave pot, comprising an upper lid made of metal and a pot body, wherein a microwave absorption layer is provided on an outer surface of a bottom wall of the pot body and is used for absorbing electromagnetic waves emitted by a microwave oven and converting the absorbed electromagnetic waves into heat; an opening of the upper lid and/or an opening of the pot body is provided with a first flange; a plurality of first through holes are formed in the first flange; silica gel members are provided on the upper and lower surfaces wrapping the first flange; and the silica gel members and the first flange are integrally formed and the silica gel members fill the first through holes, so that the silica gel members cannot be separated from the first flange after molding.

2. The microwave pot according to claim 1, wherein the opening of the pot body is provided with the first flange, each silica gel member comprises a first handle, a first main body, and a skirt edge which protrudes upwards along the first main body, and the inner side of the skirt edge is covered with the upper lid.

3. The microwave pot according to claim 2, wherein the first handles are bent downwards from inside to outside.

4. The microwave pot according to claim 2, wherein anti-skid protrusions are arranged on the surfaces of the first handles.

5. The microwave pot according to claim 1, wherein the first flange is arranged on the opening of the upper lid, a second flange is arranged on the opening of the pot body, at least one pair of second through holes is formed in the second flange, a second handle is installed on the second through holes, and the second handle comprises a handle cover and a handle base which are buckled to each other.

6. The microwave pot according to claim 5, wherein the handle cover is provided with second fixing columns which are inserted into the second through holes and are in close fit connection with an anti-skid base.

7. The microwave pot according to claim 5, wherein a top portion of the upper lid is covered with the microwave absorption layer, and the silica gel members wrap the outer surface of the upper lid and cover the microwave absorption layer; and the silica gel members are provided with clearances corresponding to the handle cover, and bottom portions of the silica gel members are attached to the second flange outside the second handle.

8. The microwave pot according to claim 1, wherein the opening of the upper lid and the opening of the pot body are provided with the first flanges, and each silica gel member comprises a first annular roll rim handle integrally formed with the upper lid, and a second annular roll rim handle integrally formed with the pot body.

9. The microwave pot according to claim 8, wherein the second annular roll rim handles are provided with limiting edges which extend upwards.

10. The microwave pot according to claim 1, wherein the opening of the upper lid is provided with the first flange, the opening of the pot body is provided with the second flange, at least one pair of second through holes is formed in the second flange, a third handle is installed on the second through holes, a top portion of the upper lid is covered with the microwave absorption layer, and the silica gel members wrap the outer surface of the upper lid and cover the microwave absorption layer; and the silica gel members are provided with the clearances corresponding to the third handle, and the bottom portions of the silica gel members are attached to the second flange outside the third handle.
